(19) United States
(12) Patent Application Publication
(10) Pub. No.: US 2012/0137126 A1
(43) Pub. Date: May 31, 2012

(54) SMART METER AND METER READING SYSTEM

(75) Inventors: Kazunari MATSUOKA, Kanagawa (JP); Jun Miyake, Kanagawa (JP); Makoto Sato, Tokyo (JP)

(73) Assignee: RENESAS ELECTRONICS CORPORATION

(21) Appl. No.: 13/305,041

(22) Filed: Nov. 28, 2011

(30) Foreign Application Priority Data
Nov. 29, 2010 (JP) 2010-264595

(51) Int. Cl. H04L 9/00

(52) U.S. Cl. 713/156

(57) ABSTRACT

The present invention provides a smart meter for use in automatic meter reading of power, gas, and the like, preventing falsification of a program and data and assuring security in a communication path. A smart meter has: a data processor receiving a measurement signal according to a use amount, computing meter read data, and performing communication control by a communication unit coupled to a network; and a secure processor having tamper resistance for internally held information and performing secure authenticating process for a remote access. The data processor encrypts computed meter read data with a public key unique to the smart meter and supplies the encrypted data to the secure processor. The secure processor decrypts the encrypted meter read data with the secret key unique to the smart meter and stores the decrypted or encrypted meter read data into a nonvolatile storage region.

### CROSS-REFERENCE TO RELATED APPLICATIONS

The disclosure of Japanese Patent Application No. 2010-264595 filed on Nov. 29, 2010 including the specification, drawings and abstract is incorporated herein by reference in its entirety.

### BACKGROUND

The present invention relates to a smart meter generating and managing meter read data according to a use amount and a meter reading system coupling the smart meter to a network and performing meter reading and relates to a technique effectively applied to, for example, a smart grid for realizing electrical power supply and demand balance.

A smart meter system as a smart grid called an AMI (Advanced Metering Infrastructure) is being practically used. In a smart meter system, a smart meter is set for each of power demanders and a server of a power supply company accesses the smart meter remotely using a bidirectional communication network, thereby performing remote meter reading of a power use amount, remote closing of a power valve, updating of an electricity price table, and the like.

Patent document 1 describes a technique of suppressing power demand at the time of a peak by a power demander itself at the time of a peak of power demand. Patent document 2 describes a technique of employing a firewall for security against hacking via a network.

There are roughly the following three threats to security of a smart meter system.

The first threat is an unauthorized access via a network. Meter read data of each house measured by a smart meter is transmitted to a server of an energy supply company via a data concentrator. On the contrary, an update file of the smart meter and, in some cases, an instruction signal for opening/closing an energy valve by remote control is/are transmitted from a server which is set in the energy supply company. Specifically, the smart meter and the energy supply company perform bidirectional communication via the WAN (Wide Area Network). When the systems are coupled to the network, the convenience improves. On the other hand, threats to security that the systems are attacked by an unauthorized access via the network increase. Consequently, each of the smart meter and the server of the energy supply company has to authenticate the other party in communication and has to perform end-to-end secure communication by encrypting communication data so that the data is not stolen. The end-to-end secure communication uses mainly SSL (Secure Socket Layer), TSL (Transport Layer Security), and the like. However, when a certificate, an encryption key, a password, or the like used for authentication is leaked, the attacker can illegally access the network, and threats such as DOS (Denial of Service) attack made by pretending the meter or the server, an act of terrorism such as knock-out of power in a whole area and the like arise.

The second is a threat of falsification of a program for a system-on-chip (SoC) microcomputer or the like as a component of the smart meter.

The third is a threat of unauthorized reading of meter read data and falsification.

A related-art general smart meter has a system-on-chip data processing device (also described as meter SoC) such as a microcomputer performing computation of a meter read value on the basis of an input such as a voltage or current value. In an on-chip nonvolatile memory in the meter SoC or an external nonvolatile memory, a price table for computation, a computation program, computed meter read data, a certificate and an encryption key for performing authentication and encryption communication with the server of the energy supply company, and the like are stored. The price table, meter read data, certificate, encryption key, and the like are encrypted with a specific key and stored in the nonvolatile storage device.

### PATENT DOCUMENTS

[Patent Document 1] Japanese Unexamined Patent Publication No. 2010-128810
[Patent Document 2] Japanese Unexamined Patent Publication No. 2007-52773

### SUMMARY

Even the price table, meter read data, certificate, encryption key, and the like are encrypted with a specific key and stored in the nonvolatile storage device, if a sufficient security measure is not taken in the nonvolatile storage device, a threat to the security occurs such that the specific key itself is illegally read from the nonvolatile storage device, the certificate and the encryption key are stolen, a hacker pretends to be a legitimate user and attacks the server, or pretends to be a legitimate server and transmits a malicious update file (patch) or a false command to the meter. Occurrence of threats to security are also assumed such that the attacker falsifies a program so as to calculate the electricity use amount to be smaller than an actual use amount, falsifies the calibration data and the electricity use amount and, further, erases a hacking log. In the meter for power, a real-time clock is used for prices by time zones. It is also assumed that the attacker falsifies the meter so that the time zone of low use price is always applied by changing the time in the real-time clock. With respect to those points, it is insufficient to only employ a nonvolatile storage device which takes measures for physical security such as a metal shield.

An object of the present invention is to provide a smart meter for use in automatic meter reading of electric power, gas, water, and the like and contributed to realize a system in which falsification of programs and data is prevented and security in a communication path to the inside and outside of the meter is assured.

The above and other objects and novel features of the present invention will become apparent from the description of the specification and the appended drawings.

Outline of representative one of inventions disclosed in the present application will be briefly described as follows

A smart meter has a data processor receiving a measurement signal according to a use amount, computing meter read data, and performing communication control by a communication unit coupled to a network, and a secure processor having tamper resistance for internal storage information and performing secure authentication process on a remote access. The secure processor has a nonvolatile storage region for holding information such as a public key unique to the smart meter, necessary for authentication by public key encryption and encrypting/decrypting process of data by the public key encryption. The data processor has a nonvolatile storage region for storing a public key unique to the smart meter. The data processor encrypts computed meter read data with a public key unique to the smart meter and supplies the encrypted data to the secure processor. The secure processor decrypts the encrypted meter read data with the secret key unique to the smart meter and stores the decrypted or encrypted meter read data into the nonvolatile storage region of itself.

By the secure authentication process with the public key encryption, security on the remote access between the server and the smart meter is assured. The secure processor maintains confidentiality of the stored data by tamper resistance, that is, resistance to physical or logical reading of internal data (physical security and security logic). The meter read data which is computed by the data processor is encrypted by the public key encryption method and the encrypted data is transferred from the data processor to the secure processor. Even if the encrypted meter read data is stolen during the transfer, it is not easy to steal the secret key itself used for the public key encryption method from the secure processor having the tamper resistance. In this point as well, the meter read data is secured. For reference to the meter read data held by the secure processor from the outside, security by the secure authentication process is assured.

An effect obtained by the representative one of the inventions disclosed in the present application will be briefly described as follows.

The present invention can be contributed to a system in which falsification of programs and data is prevented and security in a communication path to the inside/outside of the meter is assured in the smart meter for use in automatic meter reading of power, gas, water, or the like.

### BRIEF DESCRIPTION OF THE DRAWINGS

FIG. 1 is a system configuration diagram illustrating a smart meter according to an embodiment of the present invention and a meter reading system in which the smart meter is disposed;

FIG. 2 is a block diagram illustrating a secure microcomputer;

FIG. 3 is an operation explanatory diagram illustrating a process of receiving and holding meter read data computed by a meter microcomputer by the secure microcomputer (secure storage process);

FIG. 4 is an operation explanatory diagram illustrating process that a server and a smart meter alternately obtain pubic keys each signed and verified by the other party for secure authentication in conjunction with FIG. 5;

FIG. 5 is an operation explanatory diagram illustrating process that the server and the smart meter alternately obtain a common encryption key by using the public keys each signed and verified by the other party for secured authentication in conjunction with FIG. 4;

FIG. 6 is an operation explanatory diagram illustrating process that the server and the smart meter alternately obtain a common encryption key by using the public key signed and verified by the other party in conjunction with FIGS. 7 and 8.

FIG. 7 is an operation explanatory diagram illustrating process that the server and the smart meter alternately obtain a common encryption key by using the public key signed and verified by the other party in conjunction with FIGS. 6 and 8;

FIG. 8 is an operation explanatory diagram illustrating process that the server and the smart meter alternately obtain a common encryption key by using the public key signed and verified by the other part in conjunction with FIGS. 6 and 7.

FIG. 9 is an operation explanatory diagram illustrating meter read data transmitting process as an example of a secure remote access after completion of the secure authentication;

FIG. 10 is an operation explanatory diagram illustrating power valve remote control process as an example of a secure remote access after completion of the secure authentication; and

FIG. 11 is an operation explanatory diagram illustrating process (secure boot) for detecting falsification in a program of the meter microcomputer.

### DETAILED DESCRIPTION

### 1. Outline of Embodiment

First, outline of representative embodiments of the invention disclosed in the present application will be described. Reference numerals of the drawings referred to in parentheses in the description of the outline of the representative embodiments merely illustrate components designated with the reference numerals included in the concept of the components.

[1] Security Control on Remote Access and Meter Read Data Retention

A smart meter (7) according to an embodiment has a communication unit (10) to be coupled to a network (1), a data processor (12) receiving a measurement signal according to a use amount, computing meter read data, and performing communication control by the communication unit, and a secure processor (15) having tamper resistance on internal storage information and performing secure authentication process on a remote access. The secure processor has a first nonvolatile storage device (32) that stores, as information for performing the secure authentication process, a public key (K1_pub) unique to the smart meter issued from a predetermined certification authority, a secret key (K1_sec) unique to the smart meter, a public key certificate (CRTF_k1pub) as information obtained by encrypting the public key with a secret key of the certification authority, and a public key (CA_pub) of the certification authority. The data processor has a second nonvolatile storage device (16) for storing a public key (K1_pub) unique to the smart meter. The data processor encrypts computed meter read data with a public key unique to the smart meter (S1) and supplies the encrypted data to the secure processor (S2). The secure processor decrypts the encrypted meter read data with the secret key unique to the smart meter (S3), and stores the decrypted or encrypted meter read data into the first nonvolatile storage device (S4).

With the configuration, the security on the remote access between the server and the smart meter is assured by the secure authentication process with the public key encryption. The secure processor maintains confidentiality of stored data by tamper resistance, that is, resistance to physical or logical reading of internal data (physical security and security logic). The meter read data which is computed by the data processor is encrypted by the public key encryption method and the encrypted data is transferred from the data processor to the secure processor. Even if the encrypted meter read data is stolen during the transfer, it is not easy to steal the secret key itself used for the public key encryption method from the secure processor having the tamper resistance. In this point as well, the meter read data is secured. For reference to the meter read data held by the secure processor from the outside, security by the secure authentication process is assured.

Therefore, falsification of programs and data is prevented and security in the communication path to the inside and outside of the smart meter can be assured.

[2] Tamper Resistance

In the smart meter of [1], the secure processor has, to obtain the tamper resistance, a metal shield realizing physical security, a watch dog timer (34) realizing a security logic, and a coprocessor (31) for encryption used for an encrypting/decrypting process.

Strong tamper resistance can be realized.

[3] Acquisition of Public Keys of Server and Smart Meter, Signed and Verified By the Other Parties

In the smart meter of [1], as preparation for the secure authentication process on a remote access, the secure processor receives a public key certificate (CRTF_kspub) of a server obtained by encrypting the public key (Ks_pub) of the server with the secret key of the certification authority via the communication unit (S11), verifies the signature of the public key certification by using the public key (CA_pub) of the certification authority (S12), thereby obtaining the public key of the server (S13), and transmits the public key certificate (CRT_k1pub) of the smart meter obtained by encrypting the public key (K1 pub) of the smart meter with the secret key of the certification authority to the server via the communication unit (S21), so that the public key which is signature-verified by the smart meter can be stored in the server, and the public key which is signature-verified by the server can be stored in the smart meter.

The server stores the public key which is signature-verified by the smart meter, and the smart meter stores the public key which is signature-verified by the server, so that information encrypted by using the public key of the other side can be safely exchanged.

[4] Completion of Secure Authentication Process

In the smart meter of [3], the secure processor further transmits a random number (p) encrypted with the obtained public key of the server as a premaster secret to the server (S33) and transmits a signature of the smart meter generated by using the secret key of the smart meter to the server (S35), on condition that the server authenticates the smart meter (S38), arbitrary random numbers are exchanged, an encryption key (K2_sec) generated by using the exchanged random numbers and the premaster secret is shared by the smart meter and the server (S45 and S53), and the secure authentication process on a remote access is completed.

By performing the secure authentication by the method, security which is strong to the encryption communication performed by using the encryption key shared by the server and the smart meter can be realized.

[5] Response to Encryption Command

In the smart meter of [4], the data processor makes the secure processor decrypt the encrypted command supplied from the server by the remote access subjected to the secure authentication process performed by the secure processor by using the encryption key (K2_sec) (S73) and responds to the command.

Strong security can be realized on the process responding to the command given from the outside.

[6] Transfer of Meter Read Data

In the smart meter of [5], the data processor receives meter read data encrypted with the encryption key from the secure processor, and makes a communication unit transmit the meter read data in response to the remote access subjected to the secure authentication process performed by the secure processor (S62).

Strong security can be realized in response to the transfer request of the meter read data given from the outside.

[7] Prevention of Falsification of Program

In the smart meter of [1], the second nonvolatile storage device has a region for storing a program (PGM1 to PGMn) to be executed by the data processor. The first nonvolatile storage device has a region for storing a hash value (HSH_pgm, HSH_pgm to HSH_pgmn) of the program. The secure processor reads the program from the second nonvolatile storage device at a predetermined timing, computes the hash value of the program (S81), determines whether the computed hash value matches the hash value stored in the first nonvolatile storage device or not (S82), and holds the result (RSLT_err) of determination of mismatch in the first nonvolatile storage device (S83). The first nonvolatile storage device is set to be an object of a remote access of the server.

By the state where the hash value of the program executed by the data processor matches hash value stored in the first nonvolatile storage device having tamper resistance, the server can detect that the program of the data processor stored in the second nonvolatile storage device is falsified.

[8] Program Verifying Process Start Timer

In the smart meter of [7], the secure processor has a timer counter (36) generating the predetermined timing of determining match/mismatch of the hash value.

Information by which the server determines whether a program is falsified or not can be sequentially generated by the smart meter itself.

[9] Retention of Calibration Data in First Nonvolatile Storage Device

The first nonvolatile storage device stores calibration data (DAT_clb) for calibrating the measurement signal.

By storing the calibration data, fraudulence of falsifying meter read data responding to the measurement signal value can be prevented.

[10] Cumulative Power Data

In the smart meter of [1], a measurement signal according to the use amount is a voltage signal and a current signal according to a power use amount, and the meter read data is cumulative power data obtained by accumulating power sequentially computed on the basis of the voltage signal and the current signal.

The used power can be measured.

[11] Electricity Price Data

In the smart meter of [1], a measurement signal according to the use amount is a voltage signal and a current signal according to a power use amount, and the meter read data is cumulative power data obtained by accumulating power sequentially computed on the basis of the voltage signal and the current signal and electricity price data according to the cumulative power data of a predetermined period.

The used power can be measured, and the power price can be measured periodically.

[12] Electricity Price Table Data by Use Time Zones

In the smart meter of [1], the first nonvolatile storage device stores electricity price table data (DAT_chg) by use time zones used for computation of the electricity price data.

The invention can be applied to a price system in which various electricity prices are set according to the use time zones.

[13] Real-Time Clock

The smart meter of [12] further includes a real-time clock (14, 37) which counts time referred to in order to determine the electricity price table by time zones used for computation. An operation such as setting/resetting of time in the real-time clock is enabled by a remote access subjected to secure authentication process performed by the secure processor.

An attack of an attacker, of changing the time of the real-time clock so that the time zone of low use price is always applied can be prevented.

[14] Remote Access in Meter Reading System and Security of Meter Read Data

A meter reading system according to another embodiment of the invention has a server (4) and a plurality of smart meters (7) coupled to one another via a network. The smart meter includes: communication unit coupled to the network; a data processor receiving a measurement signal according to a use amount, computing meter read data, and performing communication control by the communication unit; and a secure processor having tamper resistance for internally stored information and performing secure authentication process on a remote access. The secure processor has a first nonvolatile storage device that stores, as information for performing the secure authentication process, a public key unique to the smart meter issued from a predetermined certification authority, a secret key unique to the smart meter, a public key certificate as information obtained by encrypting the public key with a secret key of the certification authority, and a public key of the certification authority. The data processor has a second nonvolatile storage device for storing a public key unique to the smart meter. The data processor encrypts computed meter read data with a public key unique to the smart meter and supplies the encrypted data to the secure processor. The secure processor decrypts the encrypted meter read data with the secret key unique to the smart meter and stores the decrypted or encrypted meter read data into the first nonvolatile storage device.

As a result, the meter reading system preventing falsification of programs and data and assuring security in a communication path to the inside and outside of the smart meter can be realized.

[15] Tamper Resistance

In the meter reading system of [14], the secure processor has, to obtain the tamper resistance, a metal shield realizing physical security, a watch dog timer realizing a security logic, and a coprocessor for encryption used for an encrypting/decrypting process.

Strong tamper resistance can be realized.

[16]Acquisition of Public Keys Subjected to Signature Verification Each other of Server and Smart Meter

In the meter reading system of [14], as preparation for the secure authentication process on a remote access, the secure processor receives a public key certificate of a server obtained by encrypting the public key of the server with the secret key of the certification authority via the communication unit, obtains the public key of the server by verifying a signature of the public key certification by using the public key of the certification authority, and transmits the public key certificate of the smart meter obtained by encrypting the public key of the smart meter with the secret key of the certification authority to the server via the communication unit, so that the public key subjected to the signature verification of the other party can be stored in the server, and the public key subjected to the signature verification of the other party can be stored in the smart meter.

The server and the smart meter store the public keys subjected to the signature-verification by each other, so that information encrypted with the public keys of the other parties can be safely exchanged.

[17] Completion of Secure Authentication Process

In the meter reading system of [16], the secure processor further transmits a random number encrypted with the obtained public key of the server as a premaster secret to the server and transmits a signature of the smart meter generated by using the secret key of the smart meter to the server, arbitrary random numbers are exchanged on condition that the server authenticates the smart meter, an encryption key generated by using the exchanged random numbers and the premaster secret is shared by the smart meter and the server, and the secure authentication process on a remote access is completed.

By performing the secure authentication by the above-described method, security strong to the encryption communication performed with the encryption key shared by the server and the smart meter can be realized.

[18] Response to Encryption Command

In the meter reading system of [17], the data processor makes the secure processor decrypt the encrypted command supplied from the server by the remote access subjected to the secure authentication process performed by the secure processor by using the encryption key and responds to the command.

Strong security to the process of responding to a command given from the outside can be realized.

[19] Transfer of Meter Read Data

In the meter reading system of [18], the data processor receives meter read data encrypted with the encryption key from the secure processor, and makes a communication unit transmit the meter read data in response to the remote access subjected to the secure authentication process performed by the secure processor.

Strong security to a request of transferring the meter read data given from the outside can be realized.

[20] Prevention of Falsification of Program

In the meter reading system of [14], the second nonvolatile storage device has a region for storing a program executed by the data processor, and the first nonvolatile storage device has a region for storing a hash value of the program. The secure processor reads the program from the second nonvolatile storage device at a predetermined timing, computes the hash value of the program, determines whether the computed hash value matches the hash value stored in the first nonvolatile storage device or not, and holds the result of determination of mismatch in the first nonvolatile storage device. The first nonvolatile storage device is set to be an object of a remote access of the server.

By the state where the hash value of a program executed by the data processor does not match the hash value stored in the first nonvolatile storage device having tamper resistance, the server can detect that the program of the data processor held in the second nonvolatile storage device is falsified.

[21] Program Verifying Process Start Timer

In the meter reading system of [20], the secure processor has a timer counter generating the predetermined timing.

Information by which the server determines whether a program is falsified or not can be sequentially generated by the smart meter itself.

[22] Reference to Result of Program Falsification Determination By Server

In the meter reading system of [20], the server refers to the result of determination of mismatch from the first nonvolatile storage device at a required timing.

The server can know the fact that the program of the smart meter is falsified.

### 2. Details of Embodiments

The embodiments will be described more specifically.

### Basic Configuration of Meter Reading System

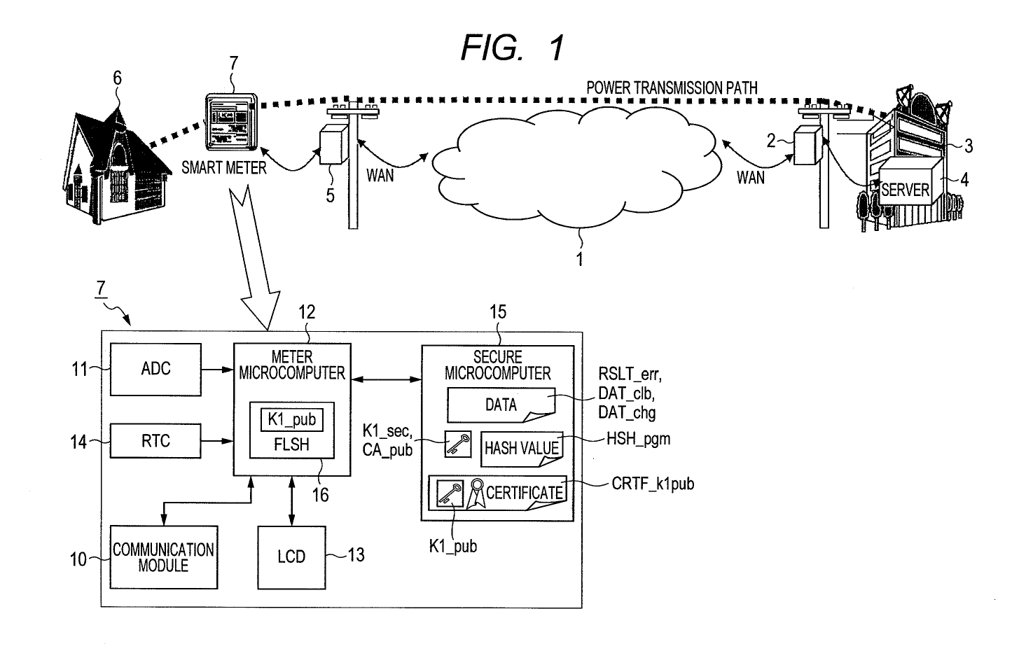

FIG. 1 illustrates a smart meter according to an embodiment of the present invention and a meter reading system in which the smart meter is disposed. The meter reading system illustrated in the diagram is applied to, for example, an electricity distribution system such as a smart grid enabling power supply management or the like according to the demand and supply state of electric power. The smart meter applied to the meter reading system is a programmable apparatus employed in place of a related-art electric power meter which records an electric power use amount in a predetermined period and is disposed for each power demander so that accumulation of electricity prices according to various menus, real-time grasp of the power use amount, remote operations such as stop of power distribution and recover of power distribution, remote meter reading, and the like can be performed.

In FIG. 1, a server 4 of a power supply company 3 coupled as a meter reading system to a bidirectional network 1 via a concentrator 2 and a smart meter 7 of a power demander 6 similarly coupled via a concentrator 5 are representatively shown. Although not illustrated, other smart meters, other servers, and the like are coupled to the concentrators 2 and 5.

The smart meter 7 has: a communication module 10 as a communication unit to be coupled to a network via the concentrator 5; an analog-digital converter (ADC) 11 for converting a voltage and current signal as a measurement signal corresponding to power supplied from the power supply company 3 to the power demander 6 and used to a digital signal; a meter microcomputer 12 as a data processor receiving the digital signal converted by the ADC 11, computing meter read data, and performing communication control or the like of the communication module 10; a liquid crystal display (LCD) 13 which is display-controlled by the meter microcomputer 12; a real-time clock (RTC) 14 which is timer-count-controlled by the meter microcomputer 12 and used for generation of a time stamp of meter read data and the like; and a secure microcomputer 15 as a secure processor having a tamper resistant performance on internal storage information and performing secure authentication process on a remote access via a network. Although not limited, the circuits 10 to 15 configuring the smart meter 7 are mounted on electrode pads formed in a predetermined wiring pattern on a wiring board.

### Meter Microcomputer

The meter microcomputer 12 has, but not limited to, input ports receiving output signals of the ACD 11 and the RTC 14, a communication interface to which the communication module 10 is coupled, a display control circuit coupled to the LCD 13, an input/output interface port as interface to the secure microcomputer 15, a central processing unit, a work RAM of the central processing unit, and a flash memory (FLSH) as an electrically-programmable second nonvolatile storage device storing an operation program of the central processing unit. In FIG. 1, reference numeral 16 is designated to the flash memory (FLSH). The program stored in the flash memory 16 is a program performing computation control of a use power amount and electricity price on the basis of an output of the ADC 11, communication protocol control using the communication module 10, counting control using an output from the RTC 14, display control on the LCD 13, control of interface with the secure microcomputer 15, and the like. Meter read data obtained by the computing control of the use power amount and the electricity price is, but not limited to, cumulative power data obtained by accumulating power sequentially computed on the basis of a voltage signal and a current signal supplied from the ADC 11 and electricity price data according to the cumulative power data in a predetermined period such as a month.

The meter microcomputer 12 is, but not limited to, realized as a multi-chip semiconductor module device such as a semiconductor integrated circuit device of a system-on-chip (SOC) or a system-in-package (SIP) and does not have tamper resistance. The ADC 11 and the RTC 14 can be mounted on the meter microcomputer 12.

### Secure Microcomputer

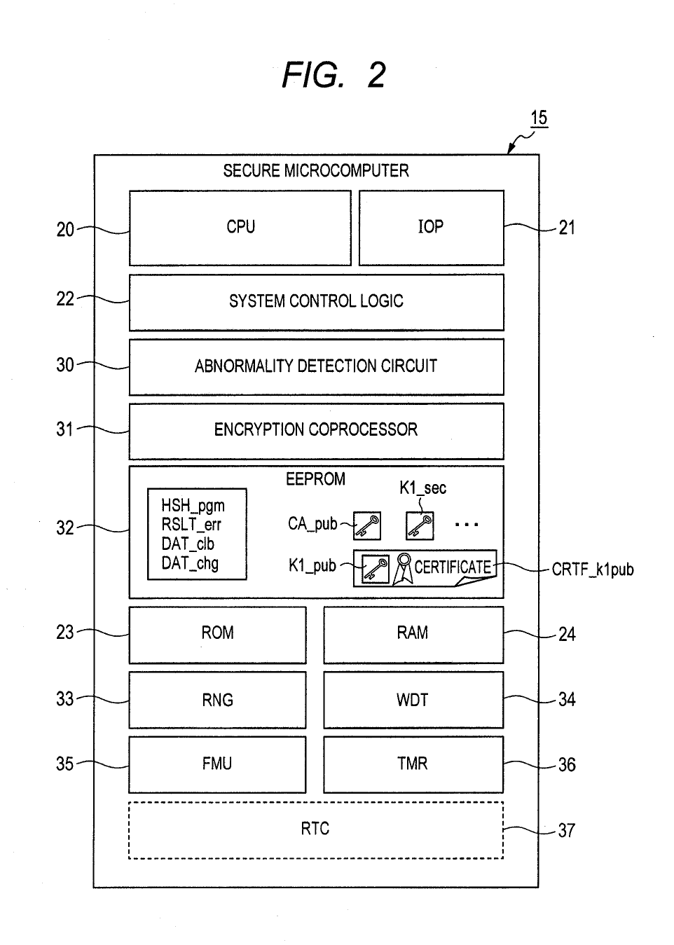

The secure microcomputer 15 includes, for example, as illustrated in FIG. 2, a central processing unit (CPU) 20 executing a program as a circuit module similar to that mounted on a general microcomputer, an input/output port (IOP) 21 as an interface to the outside, a system control logic 22 performing interrupt control, mode control, and the like, a ROM 23 storing an operation program of the CPU 20 and the like, and a RAM 24 used as a work area of the CPU 20 or the like. In addition, to realize tamper resistance, the secure microcomputer 15 has an abnormality detection circuit 30 for detecting hacking, an encryption coprocessor 31 for performing encrypting process at high speed, an EEPROM 32 as an electrically-programmable first nonvolatile storage device, a random number generating circuit (RNG) 33 for generating an encryption key, a watch dog timer (WDT) 34, a firewall management unit (FMU) 35, a timer circuit (TMR) 36, and the like. Although not limited, the secure microcomputer 15 of FIG. 2 has a real-time clock (RTC) 37 as a device which tends to become an object to be attacked and is protected by the tamper resistance of the RTC 37. In this case, the RTC 14 in FIG. 1 may not be provided.

The secure microcomputer 15 is, although not limited, preferably a microcomputer having the tamper resistance authenticated by an evaluation/certification body of ISO/IEC15408 to make reverse engineering and falsification hard. However, it is sufficient that the secure microcomputer 15 has a function similar to the above and such certification is not always necessary.

The secure microcomputer 15 includes, to obtain the tamper resistance, for example, a metal shield and irregular disposition of circuit elements realizing physical security, the watch dog timer 34 realizing the security logic, and the encryption coprocessors (a DES coprocessor and a residue multiplication coprocessor) 31 used for the encrypting/decrypting process. With the configuration, strong tamper resistance can be realized on data, a program, and the like held in the EEPROM 32 in the secure microcomputer 15 and the like. The tamper resistance such as the metal shield realizing physical security and irregular disposition of the circuit elements is provided not only for the EEPROM 32 but also to the entire secure microcomputer 15.

As the secure authentication performed by the secure microcomputer 15 at the time of a remote access, authentication using public key encryption (digital signature) is used. The secure microcomputer 15 stores, in the EEPROM 32 realizing the tamper resistance, as information for performing the secure authentication process, a public key K1_pub unique to the smart meter issued from a predetermined certification authority, a secret key K1_sec unique to the smart meter, a public key certificate CRTF_k1pub as information obtained by encrypting the public key with a secret key of the certification authority, and a public key CA_pub of the certification authority. A concrete procedure will be described later. By the secure authentication process with the public key encryption using the information, security on a remote access between the server 4 and the smart meter 7 can be assured.

The meter read data generated by the meter microcomputer 12 is stored by the EEPROM 32 having the tamper resistance. To realize data security on a path through which the generated meter read data is transferred from the meter microcomputer 12 to the secure microcomputer 15, the meter microcomputer 12 holds the public key K1_pub in the flash memory 16. The meter microcomputer 12 encrypts the computed meter read data with the public key K1_pub unique to the smart meter and supplies the encrypted data to the secure microcomputer 15. The secure microcomputer 15 decrypts the encrypted meter read data with the secret key K1_sec unique to the smart meter and stores the decrypted meter read data in the EEPROM 32. Since the secret key K1_sec is stored in the EEPROM 32 having the tamper resistance, even if the secret key K1_sec is stolen at the time of transfer of the encrypted meter read data from the meter microcomputer 12 to the secure microcomputer 15, the secret key K1_sec itself is not easily stolen and, from this viewpoint as well, the meter read data is secured.

The EEPROM 32 in the secure microcomputer 15 also stores, as an expectation value, a hash value HSH_pgm obtained from a predetermined hash function for a legitimate program in the flash memory 16 executed by the meter microcomputer 12. By executing the program in the ROM 23 at a predetermined timing, the CPU 20 reads the program of the meter microcomputer 16 from the flash memory 16, computes the hash value with the hash function, determines whether or not the computed hash value matches the hash value HSH_pgm as an expectation value held in the EEPROM 32, and holds a determination result RSLT_err of mismatch into a predetermined address in the EEPROM 32. The determination result RSLT_err of mismatch in the EEPROM 32 is an object to be remotely accessed by the server 4. By a state where the hash value of a program executed by the meter microcomputer 12 does not match the hash value HSH_pgm stored in the EEPROM 32, the server 4 can detect falsification of the operation program held in the meter microcomputer 12.

A timing of performing a process of determining the hash value is periodically generated by, for example, the timer circuit 36. The smart meter itself can sequentially generate information for the server to determine whether a program is falsified or not.

The EEPROM 32 in the secure microcomputer 15 also stores calibration data DAT_clb used to calibrate the measurement signal. The calibration data DAT_clb is, for example, data determining the conversion rate of the ADC 11 for converting voltage and current signals to digital signals and originally used for finely adjusting the conversion function of the ADC 11. Since the tamper resistance is obtained on such calibration data DAT_clb, it can be contributed to prevention of the wrong doing of falsifying meter read data responding to a measurement signal value by falsifying the calibration data.

The EEPROM 32 in the secure microcomputer 15 also stores electricity price table data DAT_chg by use time zones used to obtain electricity price data on the basis of cumulative power data computed by the meter microcomputer 12 on the basis of the voltage signal and the current signal supplied from the ADC 11. Consequently, by preventing falsification of the electricity price table data DAT_chg, an electricity price system in which electricity prices varying according to use time zones are set can be achieved.

The RTC 14 counts time which is referred to in order to determine the electricity price table data by time zones used for computation of electricity price. The operations such as setting and resetting of time in the RTC 14 can be performed by a remote access subjected to the secure authenticating process performed by the secure microcomputer 15. It can prevent an attack of an attacker of always applying the time zone of low use price by changing the time of the real-time clock.

### Threat to Security Solved by Secure Microcomputer

Threats to security solved by the secure microcomputer 15 in the meter reading system of FIG. 1 are: 1. unauthorized access, 2. falsification of a program for the meter microcomputer, and 3. falsification of data such as meter read data.

The first threat to security is solved as follows. The secure microcomputer 15 having tamper resistance holds a public key certificate and a secret key, and a remote access via the network 1, whose legitimacy or normality is confirmed by authentication using the public key encryption by the secure microcomputer 15 is enabled for the first time. In a configuration that a public key certificate and a secret key are stored in a mere EEPROM having no tamper resistance and held by each of smart meters, there is fear that the public key certificate and the secret key are easily stolen. It is assumed that authentication using the public key encryption becomes substantially meaningless. Therefore, in the meter reading system according to the embodiment, remote meter reading of the electricity use amount, remote shutoff of an electricity supply valve, and transmission of an update file to the smart meter can be fully secured. For example, an act of illegally causing a massive blackout, an illegal act of making a very-cheap nighttime electricity price system applicable by changing time of a real-time clock, and the like can be prevented.

The second threat to security is solved by storing hash values preliminarily obtained with a predetermined hash function for various programs for calculating electricity price by the meter microcomputer 12, calibration data, and the electricity price table data in the EEPROM 32 in the secure microcomputer 15 having the tamper resistance.

The third threat to security is solved by storing the meter read data, calibration data, and a determination result as a hacking log in the EEPROM 32 by the secure microcomputer 15 having the tamper resistance.

### Secure Storage

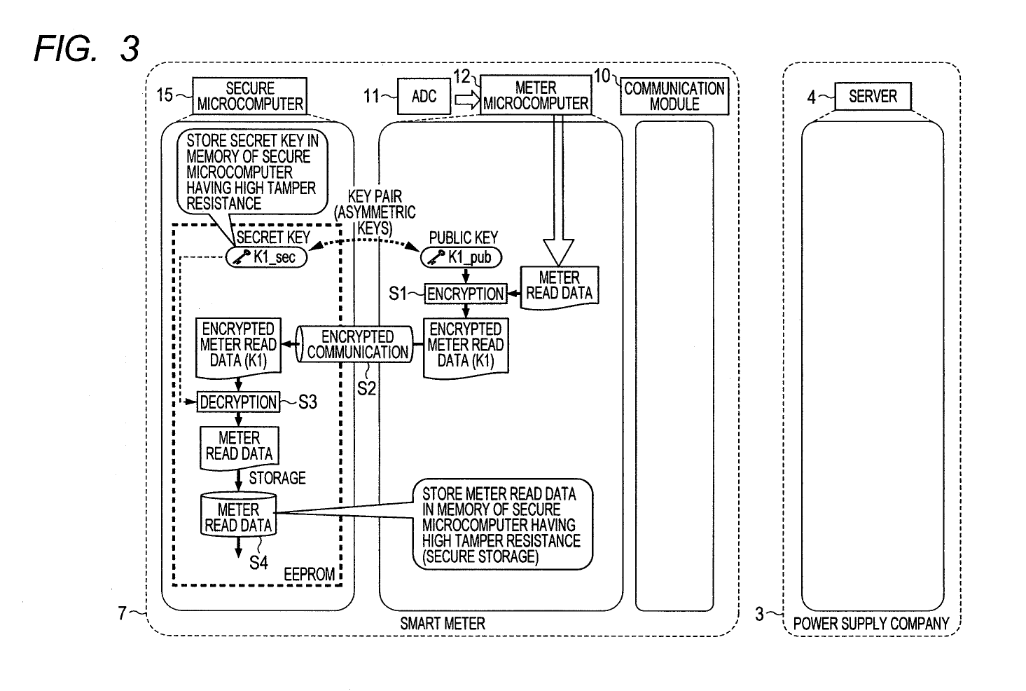

FIG. 3 illustrates process (secure storage process) that the secure microcomputer 15 receives and holds the meter read data computed by the meter microcomputer 12.

As preparation before system operation, the secure microcomputer 15 for the smart meter 7 stores, in the EEPROM 32, the public key K1_pub to the smart meter 7 to be used for signature verification or the like, the secret key K1_sec to the smart meter, the public key certificate CRTF_k1pub of the smart meter obtained by encrypting the public key K1_pub with a secret key of a certification authority, and the public key CA_pub of the certification authority. The meter microcomputer 12 stores the public key K1_pub in the flash memory 16.

The meter microcomputer 12 encrypts the meter read data with the public key K1_pub unique to the smart meter 7 (S1), and transmits the encrypted meter read data to the secure microcomputer 15 via a predetermined mounting wire of the smart meter 7 (S2). The secure microcomputer 15 decrypts the encrypted meter read data with the secret key K1_sec unique to the smart meter 7 (S3) and stores the decrypted data in the EEPROM 32 (S4).

### [Secure Authentication]

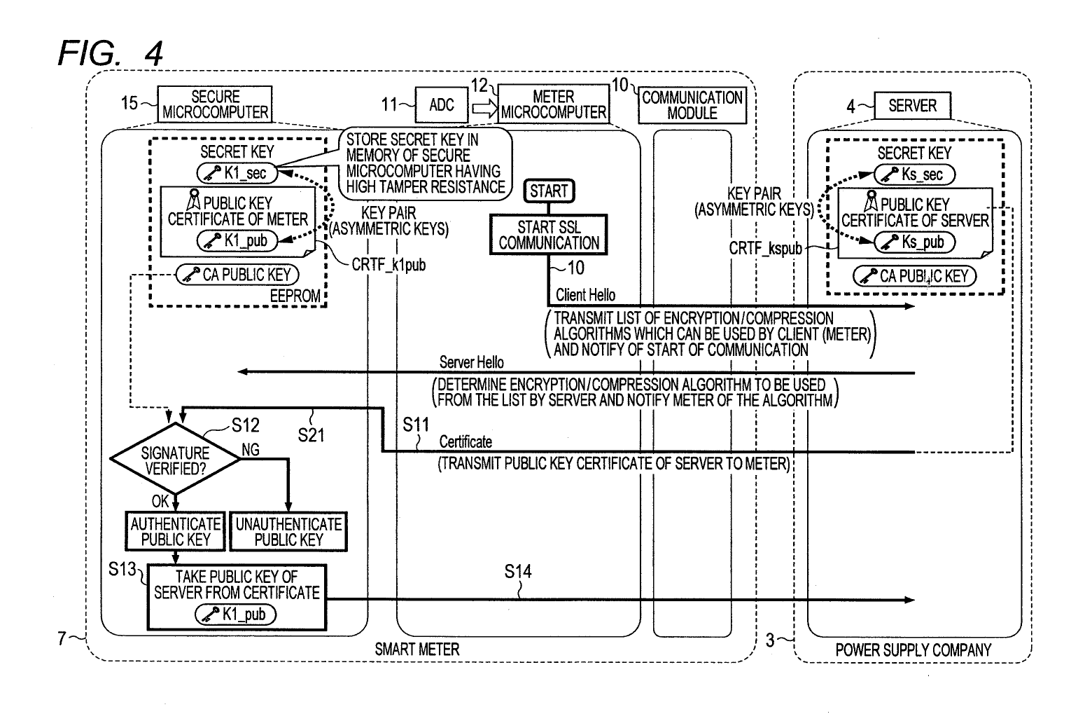

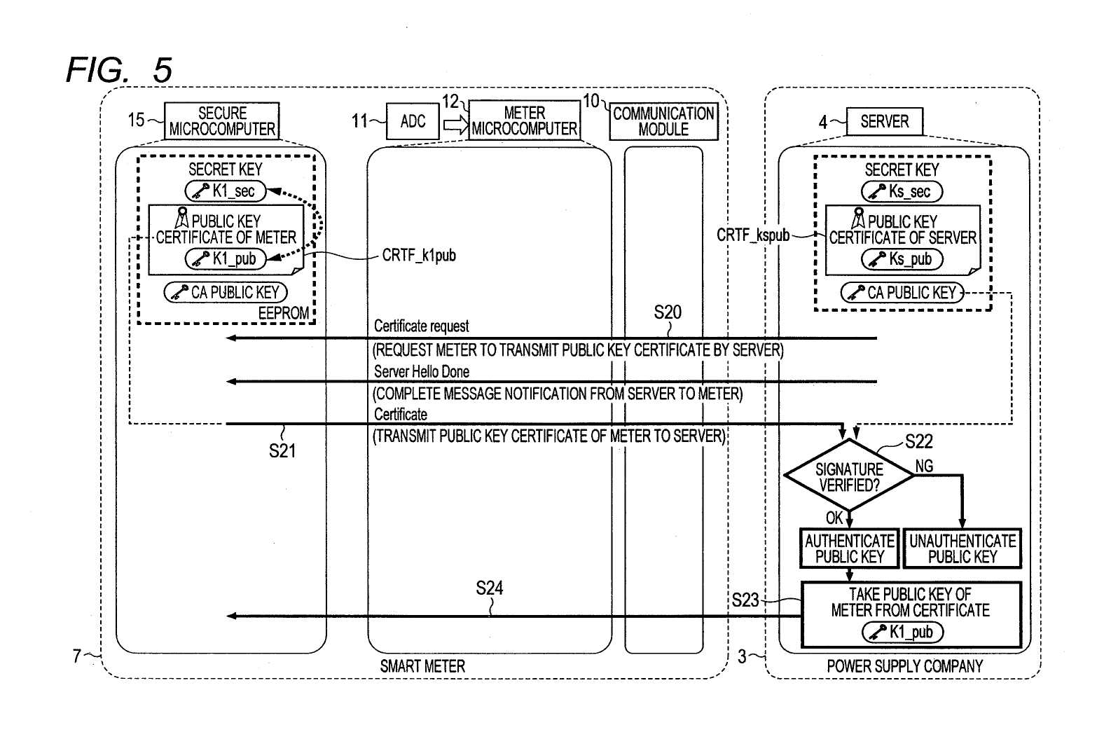

FIGS. 4 and 5 illustrate process that the server and the smart meter alternately obtain the public keys which are signature-verified, of the others for secure authentication.

When the meter microcomputer 12 notifies the server 4 of start of SSL communication (S11), in response to it, the server 4 transmits a public key certificate CRTF_kspub of the server 4 (a certificate obtained by encrypting the public key Ks_pub of the server issued by a certification authority with a secret key of the certification authority) to the smart meter 7, and the secure microcomputer 15 receives the public key certificate CRTF_kspub (S11). The secure microcomputer 15 decrypts the public key certificate CRTF_kspub with the public key of the certification authority (S12). In the case where the public key certificate CRTF_kspub can be authenticated, the public key Ks_pub accompanying the public key certificate CRTF_kspub is taken and held (S13), and the fact is notified to the server 4 (S14).

In response to the notification, the server 4 requests the meter microcomputer 7 to transmit the public key certificate CRTF_k1pub of the smart meter (S21). In response to the request, the secure microcomputer 15 transmits the public key certificate CRTF_k1pub of the smart meter to the server 4 (S21). The server 4 decrypts the public key certificate CRTF_k1pub with the public key of the certification authority and performs signature verification (S22). When the authentication succeeds, the public key K1_pub accompanying the public key certificate CRTF_k1pub is taken and held (S23), and the fact is notified to the server 4 (S24). As a result, the smart meter 7 comes to have the public key Ks_pub of the server 4, and the server 4 comes to have the public key K1_pub of the smart meter 7.

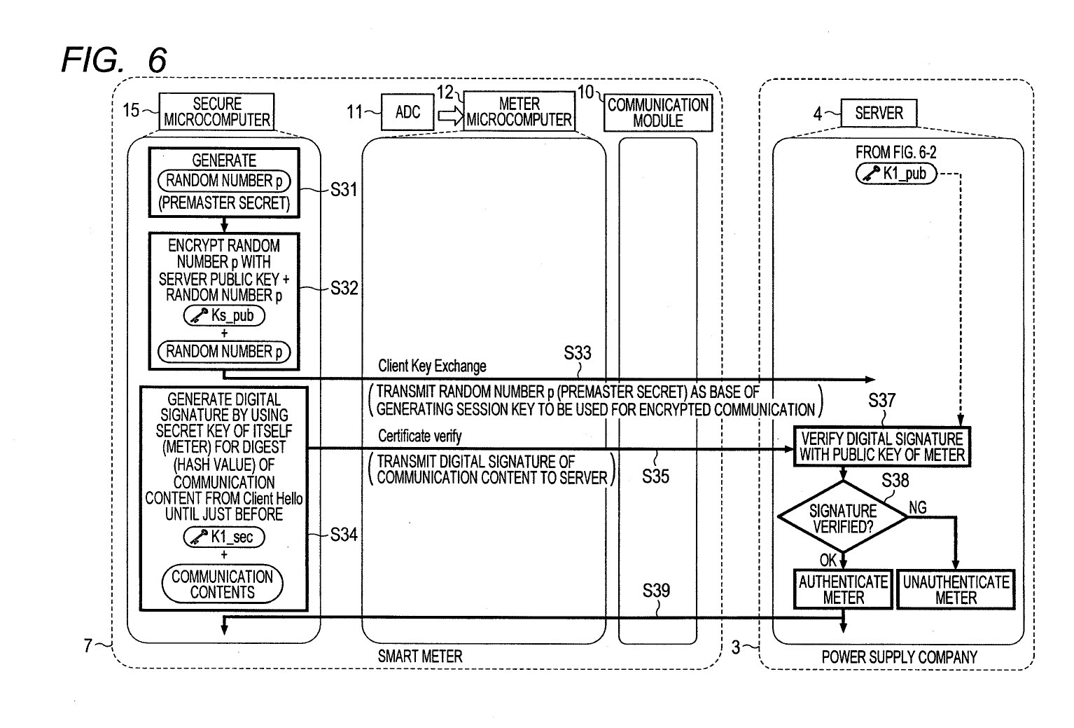

FIGS. 6 to 8 illustrate process that the server and the smart meter obtain a common encryption key by using the public keys which are signature-verified each other.

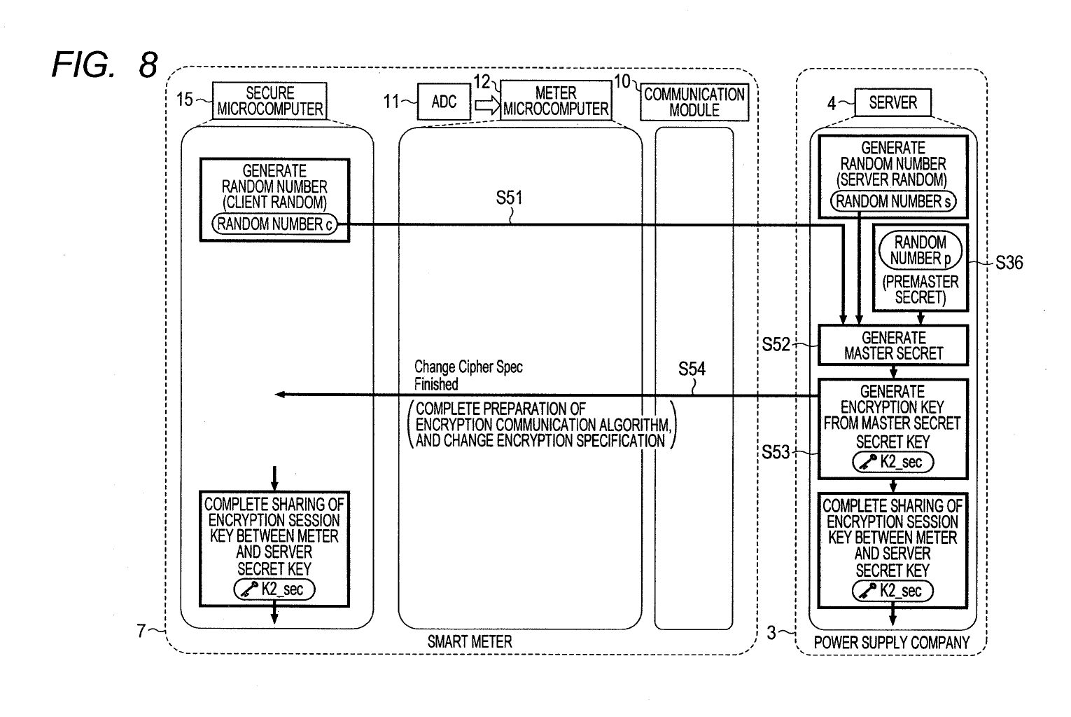

In FIG. 6, in response to the notification in step S24 in FIG. 5, the secure microcomputer 15 generates a random number “p” as a premaster secret (S31), encrypts the random number “p” with the public key Ks_pub of the server (S32), and transmits the resultant to the server 4 (S33). Further, the secure microcomputer 15 obtains a hash value (digest version of the communication content) generated using a predetermined hash function on the communication content (Client Hello) in step S10 to the communication content given to the server 4, generates a digital signature encrypted with the secret key K1_sec of itself (S34), and transmits the digital signature to the server (S35). The server 4 decrypts the random number “p” with the secret key Ks_sec of itself and holds the resultant (S36 in FIG. 8). Further, the server 4 decrypts the received digital signature with the public key K1_pub of the secure microcomputer (S37) and verifies the signature (S38). When the authentication succeeds, the fact is notified to the secure microcomputer 15 (S39).

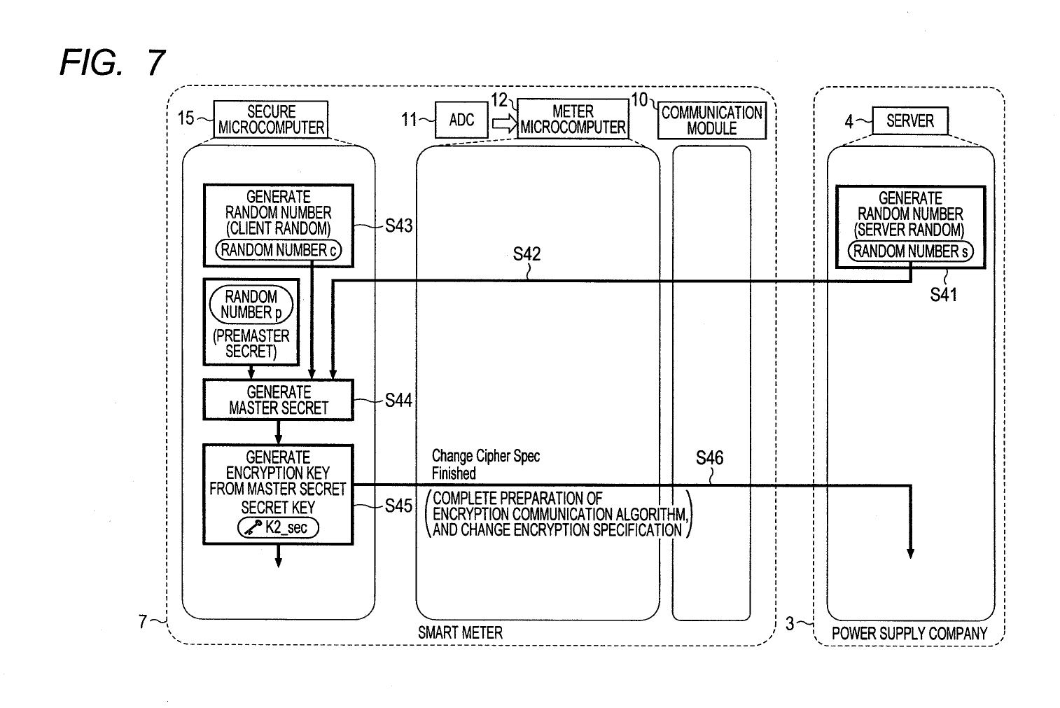

In FIG. 7, the server 4 generates a random number “s” as a server random (S41) and transmits it to the secure microcomputer 15 (S42). The secure microcomputer 15 generates a random number “c” as a client random (S43), generates a master secret using the random number “c” and the received random numbers “s” and “p” (S44), and generates an encryption key K2_sec as a secret key using the master secret (S45). Finally, the secure microcomputer 15 notifies the server 4 of completion of preparation of an encrypted communication algorithm using the secret key K2_sec and the change in the cipher specification (S46).

In FIG. 8, the secure microcomputer 15 transmits the random number “c” to the server 4 together with the notification in step S46 (S51). The server 4 generates a master secret by using the random numbers “c”, “s”, and “p” (S52), and generates the encryption key K2_sec as a secret key using the master secret (S53). The server 4 notifies the secure microcomputer 15 of completion of the preparation of the encrypted communication algorithm using the secret key K2_sec and the change in the cipher specification (S54).

As a result, the state where the encryption key K2_sec is commonly used is established in the server 4 and the secure microcomputer 15 of the smart meter 7, and the secure authentication process is completed.

### Secure Remote Access

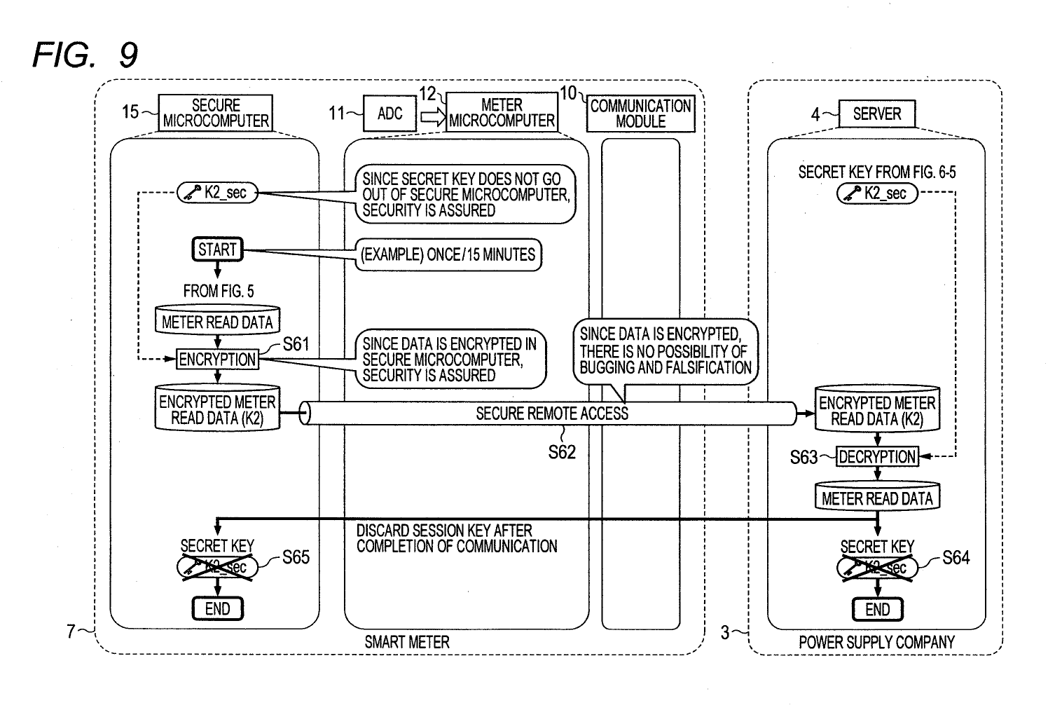

FIG. 9 shows meter read data transmitting process as an example of a secure remote access after completion of the secure authentication. For example, the meter read data computed every 15 minutes in the secure microcomputer 15 is held in the EEPROM 32 in accordance with the procedure in FIG. 3. After completion of the secure authentication, the secure microcomputer 15 encrypts the meter read data with the encryption key K2_sec (S61), and transmits the encrypted read meter data to the server 4 via the network 1 (S62). The server 4 decrypts the encrypted read meter data with the encryption key K2_sec and uses the decrypted data (S63). The encryption key K2_sec used is discarded at the end of the communication of the meter read data (S64 and S65).

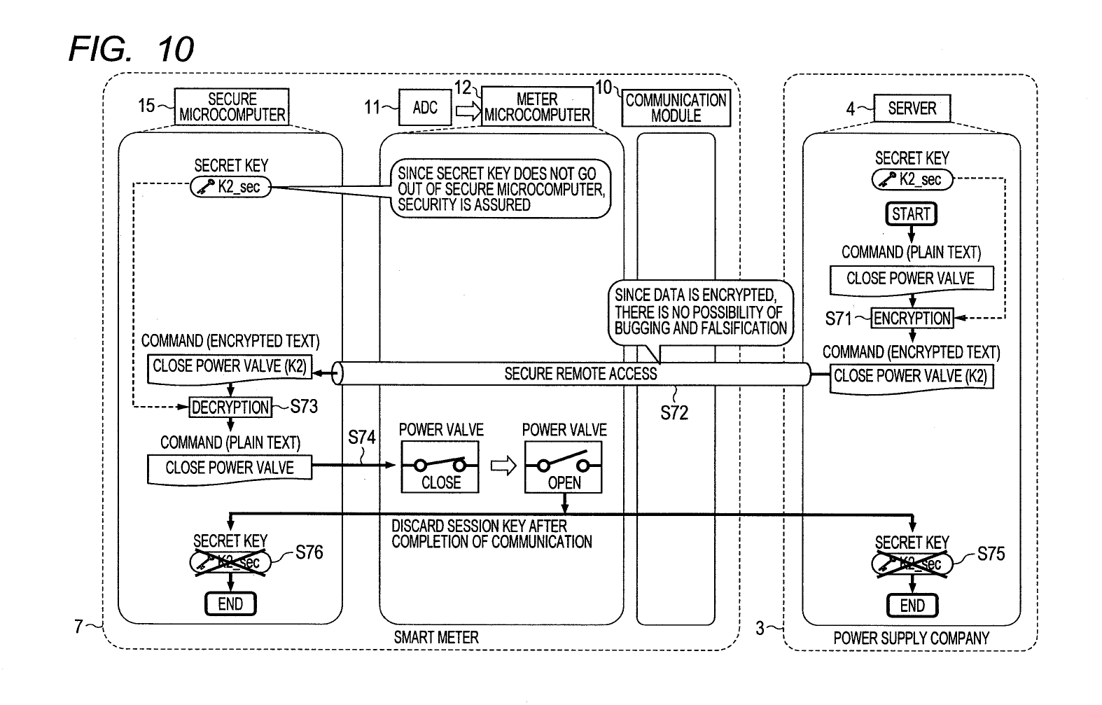

FIG. 10 illustrates power-valve remote operation process as an example of the secure remote access after completion of the secure authentication. As described above with reference to FIGS. 4 to 9, the secure authentication is performed in such a manner that the meter verifies the signature of the certificate with the public key of the server by using the public key of the certification authority to confirm that the other party in communication is right one. On the other hand, the power-valve remote operation is based on a request from the server side. The secure authentication is started by checking the meter by the server. In short, the authentication is performed in the order opposite to that in FIGS. 4 to 9 and, at last, the server and the secure microcomputer share the encryption key K2_sec as a session key.

In this case, the server encrypts a command to give an instruction to close the power valve with the encryption key K2_sec (S71) and transmits the encrypted command to the smart meter 7 via the network 1 (S72). The secure microcomputer 15 of the smart meter which receives the encrypted command decrypts the encrypted command with the encryption key K2_sec (S73), and makes the meter microcomputer 12 execute an operation of closing the power valve (S74). Before completion of the operation of closing the power valve, the encryption key K2_sec is discarded (S75 and S76).

Although not illustrated, updating of a program executed by the meter microcomputer 12, updating of the electricity price table, and operation of setting time in the real-time clock 14 can be also secured by secure authentication process and encryption of an operation command similar to the power valve remote operation.

### Secure Boot

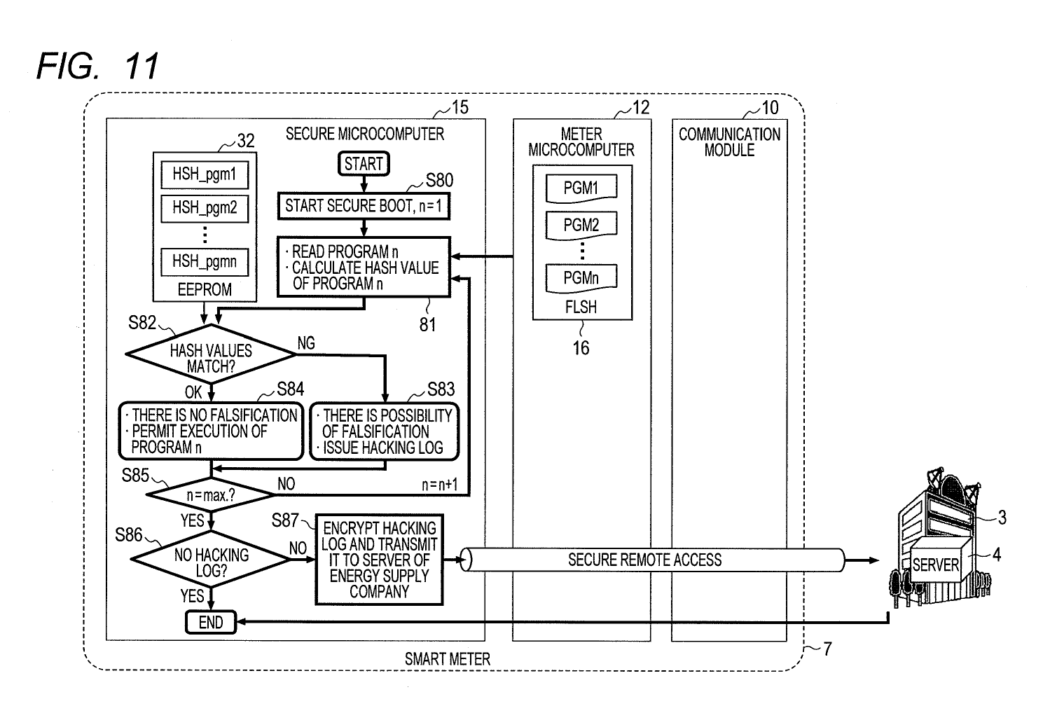

FIG. 11 illustrates a flowchart of process (secure boot) for detecting falsification of the program in the meter microcomputer 12. For the secure boot, hash values HSH_pgm1 to HSH_pgmn obtained with a predetermined hash function for programs PGM1 to PGMn stored in the flash memory 16 of the meter microcomputer 15 are stored in the EEPROM 32 of the secure microcomputer 15.

When the secure boot process is started by the secure microcomputer 15 (S80), a program of a program number pointed by a pointer “n” of the program number is read from the meter microcomputer 12, and a hash value of the program is calculated (S81). The calculated hash value is compared with the hash value HSH_pgm1 preliminarily obtained in the EEPROM 32, and match/mismatch is determined (S82). In the case of a mismatch, there is the possibility of falsification. A hacking log in which the determination result RSLT_err of mismatch is written is issued and held in the EEPROM 32 (S83). In the case of a mismatch, although not limited, a program valid bit provided for each program number is set to “invalid” to inhibit execution of the program. If the determination result is not “mismatch”, it is determined that there is no falsification, and the meter microcomputer 12 is permitted to execute the program of the program number n1 (S84). The program execution permission is given by, but not limited, maintaining the program valid bit provided for each program number “valid”. The processes in steps S81 to S84 are repeated until “n” reaches the final number (S85). Finally, the presence or absence of a hacking log is determined (S86). In the case where there is a hacking log, the hacking log is encrypted with the encryption key K2_sec and the resultant is transmitted to the server 4 (S87). Although not limited, the secure boot process is performed, for example, once a day in accordance with the setting in the timer 36.

The hacking log may include not only the result of the secure boot process but also a result of abnormality detection by the abnormality detection circuit 30 for detecting abnormality in the power supply voltage, clock frequency for synchronization operation, and the like.

Although the present invention achieved by the inventors herein have been concretely described above on the basis of the embodiments, obviously, the invention is not limited to the embodiments but can be variously changed without departing from the gist.

For example, a public key unique to the smart meter used for encryption by a data processor typified by the meter microcomputer may be transferred from a first nonvolatile storage device of the secure processor typified by the secure microcomputer to a second nonvolatile storage device.

The electricity charge may be calculated by a server. In this case, therefore, the smart meter calculates only the power amount and does not have to calculate the electricity charges.

In the embodiment, by configuring the meter microcomputer realizing the data processor and the secure microcomputer realizing the secure processor by different semiconductor devices, the microcomputer for an IC card and the like come to be able to be used for the secure processor. A device in which both of the data processor and the secure processor are formed on a single chip can be also used.

The second nonvolatile storage device in the data processor may be any of an internal memory of the processor or an external memory.

The certification authority may be a private certification authority such as an association of companies in the same business.

The present invention is applicable also to energy meters of water, gas, and the like except for electric power.

What is claimed is:

1. A smart meter having a communication unit to be coupled to a network, a data processor receiving a measurement signal according to a use amount, computing meter read data, and performing communication control by the communication unit, and a secure processor having a tamper resistant performance on internal storage information and performing secure authentication process on a remote access,
wherein the secure processor has a first nonvolatile storage device that stores, as information for performing the secure authentication process, a public key unique to the smart meter issued from a predetermined certification authority, a secret key unique to the smart meter, a public key certificate as information obtained by encrypting the public key with a secret key of the certification authority, and a public key of the certification authority,
wherein the data processor has a second nonvolatile storage device for storing a public key unique to the smart meter,
the data processor encrypts computed meter read data with a public key unique to the smart meter and supplies the encrypted data to the secure processor, and
wherein the secure processor decrypts the encrypted meter read data with the secret key unique to the smart meter and stores the decrypted or encrypted meter read data into the first nonvolatile storage device.

2. The smart meter according to claim 1, wherein the secure processor has, to obtain the tamper resistance, a metal shield realizing physical security, a watch dog timer realizing a security logic, and a coprocessor for encryption used for an encrypting/decrypting process.

3. The smart meter according to claim 1, wherein as preparation for the secure authentication process on a remote access, the secure processor receives a public key certificate of a server obtained by encrypting the public key of the server with the secret key of the certification authority via the communication unit, obtains the public key of the server by verifying a signature of the public key certification by using the public key of the certification authority, and transmits the public key certificate of the smart meter obtained by encrypting the public key of the smart meter with the secret key of the certification authority to the server via the communication unit, so that the public key which is signature-verified by the smart meter can be stored in the server, and the public key which is signature-verified by the server can be stored in the smart meter.

4. The smart meter according to claim 3, wherein the secure processor further transmits a random number encrypted with the obtained public key of the server as a premaster secret to the server and transmits a signature of the smart meter generated by using the secret key of the smart meter to the server, arbitrary random numbers are exchanged on condition that the server authenticates the smart meter, an encryption key generated by using the exchanged random numbers and the premaster secret is shared by the smart meter and the server, and the secure authentication process on a remote access is completed.

5. The smart meter according to claim 4, wherein the data processor makes the secure processor decrypts the encrypted command supplied from the server by the remote access subjected to the secure authentication process performed by the secure processor by using the encryption key and responds to the command.

6. The smart meter according to claim 5, wherein the data processor receives meter read data encrypted with the encryption key from the secure processor, and makes a communication unit transmit the meter read data in response to the remote access subjected to the secure authentication process performed by the secure processor.

7. The smart meter according to claim 1,
wherein the second nonvolatile storage device has a region for storing a program executed by the data processor,
wherein the first nonvolatile storage device has a region for storing a hash value of the program,
wherein the secure processor reads the program from the second nonvolatile storage device at a predetermined timing, computes the hash value of the program, determines whether the computed hash value matches the hash value stored in the first nonvolatile storage device or not, and holds the result of determination of mismatch in the first nonvolatile storage device, and
wherein the first nonvolatile storage device is set to be an object of a remote access of the server.

8. The smart meter according to claim 7, wherein the secure processor has a timer counter generating the predetermined timing.

9. The smart meter according to claim 1, wherein the first nonvolatile storage device has a region for storing calibration data for calibrating the measurement signal.

10. The smart meter according to claim 1, wherein a measurement signal according to the use amount is a voltage signal and a current signal according to a power use amount, and
wherein the meter read data is cumulative power data obtained by accumulating power sequentially computed on the basis of the voltage signal and the current signal.

11. The smart meter according to claim 1,
wherein a measurement signal according to the use amount is a voltage signal and a current signal according to a power use amount, and
wherein the meter read data is cumulative power data obtained by accumulating power sequentially computed on the basis of the voltage signal and the current signal and electricity price data according to the cumulative power data of a predetermined period.

12. The smart meter according to claim 1, wherein the first nonvolatile storage device has a region storing electricity price table data by use time zones used for computation of the electricity price data.

13. The smart meter according to claim 12, further comprising a real-time clock which counts time referred to in order to determine the electricity price table by time zones used for computation,
wherein an operation on the real-time clock is enabled by a remote access subjected to secure authentication process performed by the secure processor.

14. A meter reading system having a server and a plurality of smart meters coupled to one another via a network,
wherein the smart meter includes:
a communication unit coupled to the network;
a data processor receiving a measurement signal according to a use amount, computing meter read data, and performing communication control by the communication unit; and
a secure processor having tamper resistance for internally stored information and performing secure authentication process on a remote access,
wherein the secure processor has a first nonvolatile storage device that stores, as information for performing the secure authentication process, a public key unique to the smart meter issued from a predetermined certification authority, a secret key unique to the smart meter, a public key certificate as information obtained by encrypting the public key with a secret key of the certification authority, and a public key of the certification authority,
wherein the data processor has a second nonvolatile storage device for storing a public key unique to the smart meter,
wherein the data processor encrypts computed meter read data with a public key unique to the smart meter and supplies the encrypted data to the secure processor, and
wherein the secure processor decrypts the encrypted meter read data with the secret key unique to the smart meter and stores the decrypted or encrypted meter read data into the first nonvolatile storage device.

15. The meter reading system according to claim 14, wherein the secure processor has, to obtain the tamper resistance, a metal shield realizing physical security, a watch dog timer realizing a security logic, and a coprocessor for encryption used for an encrypting/decrypting process.

16. The meter reading system according to claim 14, wherein as preparation for the secure authentication process on a remote access, the secure processor receives a public key certificate of a server obtained by encrypting the public key of the server with the secret key of the certification authority via the communication unit, obtains the public key of the server by verifying a signature of the public key certification by using the public key of the certification authority, and transmits the public key certificate of the smart meter obtained by encrypting the public key of the smart meter with the secret key of the certification authority to the server via the communication unit, so that the public key which is signature-verified by the smart meter can be stored in the server, and the public key which is signature-verified by the server can be stored in the smart meter.

17. The meter reading system according to claim 16, wherein the secure processor further transmits a random number encrypted with the obtained public key of the server as a premaster secret to the server and transmits a signature of the smart meter generated by using the secret key of the smart meter to the server, arbitrary random numbers are exchanged on condition that the server authenticates the smart meter, an encryption key generated by using the exchanged random numbers and the premaster secret is shared by the smart meter and the server, and the secure authentication process on a remote access is completed.

18. The meter reading system according to claim 17, wherein the data processor makes the secure processor decrypt the encrypted command supplied from the server by the remote access subjected to the secure authentication process performed by the secure processor by using the encryption key and responds to the command.

19. The meter reading system according to claim 18, wherein the data processor receives meter read data encrypted with the encryption key from the secure processor, and makes a communication unit transmit the meter read data in response to the remote access subjected to the secure authentication process performed by the secure processor.

20. The meter reading system according to claim 14,
wherein the second nonvolatile storage device has a region for storing a program executed by the data processor,
wherein the first nonvolatile storage device has a region for storing a hash value of the program,
wherein the secure processor reads the program from the second nonvolatile storage device at a predetermined timing, computes the hash value of the program, determines whether the computed hash value matches the hash value stored in the first nonvolatile storage device or not, and holds the result of determination of mismatch in the first nonvolatile storage device, and
wherein the first nonvolatile storage device is set to be an object of a remote access of the server.

21. The meter reading system according to claim 20, wherein the secure processor has a timer counter generating the predetermined timing.

22. The meter reading system according to claim 20, wherein the server refers to the result of determination of mismatch from the first nonvolatile storage device at a required timing.
